(19) United States
(12) Patent Application Publication
(10) Pub. No.: US 2023/0025739 A1
(43) Pub. Date: Jan. 26, 2023

(54) Dataset Refining with Machine Translation Quality Prediction

(71) Applicant: Google LLC, Mountain View, CA (US)

(72) Inventors: Junpei Zhou, Bellevue, WA (US); Yuezhang Li, MountainView, CA (US); Ciprian Chelba, Palo Alto, CA (US); Fangxiaoyu Feng, Cupertino, CA (US); Bowen Liang, Sunnyvale, CA (US); Pidong Wang, Cupertino, CA (US)

(21) Appl. No.: 17/852,863

(22) Filed: Jun. 29, 2022

Related U.S. Application Data
(63) Continuation of application No. PCT/US2021/040492, filed on Jul. 6, 2021.

(51) Int. Cl. G06F 40/58; G06N 3/08; G06F 40/51

(52) U.S. Cl. CPC G06F 40/58; G06N 3/08; G06F 40/51

(57) ABSTRACT

Aspects of the technology employ a machine translation quality prediction (MTQP) model to refine datasets that are used in training machine translation systems. This includes receiving, by a machine translation quality prediction model, a sentence pair of a source sentence and a translated output (802). Then performing feature extraction on the sentence pair using a set of two or more feature extractors, where each feature extractor generates a corresponding feature vector (804). The corresponding feature vectors from the set of feature extractors are concatenated together (806). And the concatenated feature vectors are applied to a feedforward neural network, in which the feedforward neural network generates a machine translation quality prediction score for the translated output (808).

### CROSS-REFERENCE TO RELATED APPLICATIONS

The present application is a continuation of International Application No. PCT/US2021/40492, filed Jul. 6, 2021, the entire disclosure of which is hereby incorporated herein by reference.

### BACKGROUND

Machine-based translations can be used to translate text from one language to another. Machine translation quality estimation or prediction involves evaluating the output of a machine translation system without access to a “gold” label sequence. Machine translation models can be trained with large parallel datasets, such as millions (or more) of sentence pairs. However, real-world datasets may contain a substantial amount of noisy data. Use of such data by a machine translation model can produce poor training results, which, in turn, can result in low quality translations.

### BRIEF SUMMARY

Aspects of the technology employ a machine translation quality prediction (MTQP) model to refine datasets that are used in training machine translation systems. The MTQP model is configured to provide indications on the quality of a sentence pair. Given a large dataset containing sentence pairs (e.g., hundreds of thousands, millions or billions of sentence pairs) from real-world datasets, the MTQP model assigns a score to each sentence pair. The model flags low-scoring pairs that fall below a selected threshold. The resultant high quality dataset pairs can then be used to train various types of machine translation models, such as neural machine translation (NMT) models. Example implementations are thus directed to a specific technical implementation of a machine translation training system which filters training data using an MTQP model and then uses the filtered training data to train a machine translation model.

According to one aspect of the technology, a computer-implemented method comprises receiving, by a machine translation quality prediction model, a sentence pair of a source sentence and a translated output; performing feature extraction on the sentence pair using a set of two or more feature extractors, each feature extractor generating a corresponding feature vector; concatenating the corresponding feature vectors from the set of feature extractors together; and applying the concatenated feature vectors to a feedforward neural network, the feedforward neural network generating a machine translation quality prediction score for the translated output.

In one example, the method further comprises storing the machine translation quality prediction score in a database in association with the translated output. In another example, the method further comprises transmitting the machine translation quality prediction score to a user. In either case, the set of two or more feature extractors may comprise at least two of a Quasi-MT feature extractor, a neural machine translation feature extractor, a language model extractor, and a LogPr feature extractor. The Quasi-MT feature extractor may use internal scores of a Quasi-MT model that is trained by trying to predict each token in a gold-label sentence by using information in both the source sentence and the gold-label sentence. The neural machine translation feature extractor may use internal scores from at least a decoder of a neural machine translation model. The language model extractor may use internal scores from two kinds of language models. Here, a first one of the language models is trained on a selected corpus of a source language, and a second one of the language models is a contrastive language model that is first trained on the selected corpus and then incrementally trained on a corpus formed by source sentences in a set of training sentence pairs.

In a further example, the method also includes determining whether the machine translation quality prediction score exceeds a quality threshold, and when the machine translation quality prediction score does not exceed the quality threshold, filtering the translated output. Filtering the translated output may comprise storing a flag with the translated output to indicate that the machine translation quality prediction score does not exceed the quality threshold. Filtering the translated output may comprise removing the translated output from a corpus of translated output sentences.

In another example, the method further comprises determining whether the machine translation quality prediction score exceeds a quality threshold, and when the machine translation quality prediction score exceeds the quality threshold, adding the translated output to a corpus of translated output sentences. In yet another example, the method further includes training a machine translation model using the translated output when the machine translation quality prediction score exceeds a quality threshold.

In a further example, the method also includes creating a curated data set of source sentences and corresponding translated outputs, where each translated output exceeds a quality threshold, and then training a machine translation model using the curated data set. The trained machine translation model may be a neural machine translation model.

According to another aspect of the technology, a system is provided that comprises memory configured to store machine translation quality prediction information and one or more processors operatively coupled to the memory. The one or more processors are configured to implement a machine translation quality prediction model by: reception of a sentence pair of a source sentence and a translated output; performance of feature extraction on the sentence pair using a set of two or more feature extractors, each feature extractor generating a corresponding feature vector; performing a concatenation of the corresponding feature vectors from the set of feature extractors together; and application of the concatenated feature vectors to a feedforward neural network, in which the feedforward neural network is configured to generate a machine translation quality prediction score for the translated output.

In one example, the set of two or more feature extractors comprises at least two of a Quasi-MT feature extractor, a neural machine translation feature extractor, a language model extractor, and a LogPr feature extractor.

In another example, the one or more processors are further configured to: determine whether the machine translation quality prediction score exceeds a quality threshold; and when the machine translation quality prediction score does not exceed the quality threshold, filter the translated output. The one or more processors may be configured to filter the translated output by storing a flag with the translated output to indicate that the machine translation quality prediction score does not exceed the quality threshold. The one or more processors may be further configured to: determine whether the machine translation quality prediction score exceeds a quality threshold; and when the machine translation quality prediction score exceeds the quality threshold, add the translated output to a corpus of translated output sentences. The one or more processors may be further configured to train a machine translation model using the translated output when the machine translation quality prediction score exceeds a quality threshold. And the one or more processors may be further configured to: create a curated data set of source sentences and corresponding translated outputs, where each translated output exceeds a quality threshold; store the curated data set in the memory; and train a machine translation model using the curated data set.

### BRIEF DESCRIPTION OF THE DRAWINGS

FIG. 1 illustrates a set of example scenarios for machine translation configurations in accordance with aspects of the technology.

FIG. 2A illustrates an example quasi-machine translation model in accordance with aspects of the technology.

FIG. 2B illustrates an example quality estimation architecture in accordance with aspects of the technology.

FIG. 3 illustrates a general model approach in accordance with aspects of the technology.

FIG. 4 illustrates an example approach for projecting a source sentence and a translated output to a feature vector, in accordance with aspects of the technology.

FIG. 5 illustrates an example model structure for generating a predicted quality score in accordance with aspects of the technology.

FIG. 6 illustrates a model workflow in accordance with aspects of the technology.

FIGS. 7A-B illustrate a system for use with aspects of the technology.

FIG. 8 illustrates a method in accordance with aspects of the technology.

### DETAILED DESCRIPTION

Overview

Machine translation quality prediction (MTQP), also referred to as machine translation quality estimation (MTQE), aims to evaluate the output of a machine translation system without access to reference translations. For example, given a source sentence (a sentence in a source language) and a translation output (a sentence generated by a machine translation system), it is beneficial to be able to predict the quality score of this translation, even without knowing the machine translation system or the gold-label sentence (e.g., a human generated reference translation sentence). In particular, MTQP predicts if the translation output matches the meaning of the source sentence, and whether the target sentence is fluent.

Different metrics may be used to evaluate the quality of a machine translation. For instance, a BLEU score that is based on n-gram precision may be employed. Here, a BLEU score may be calculated between translation output and gold-label sentences. A parallel corpus containing source sentences and corresponding gold-label sentences may be used to evaluate the translation quality. For instance, the BLEU metric may be averaged on a corpus to provide an indication of how well the machine translation system is trained. MTQP may be used to evaluate the quality of a specific translation output given the source sentence. In contrast to BLEU, it may not be meaningful to calculate the average MTQP for a whole corpus, because MTQP is beneficial to flag low-quality translation outputs that would then be subject to next-step post-editing.

By way of example, there can be a significant benefit to an application service provider or other customer to receive a confidence score (quality estimation) along with translation. This score can be used to judge whether machine translation can be directly used without post-editing, or how much post-editing is needed. Since human post-editing can be the most significant cost in the localization workflow, the confidence score feature is of high importance to reduce cost, and provide additional information on translation quality.

For situations where post-editing may be required, MTQP allows experts to concentrate on translations that are estimated to be of low-quality, further reducing post-editing cost. For example, a service provider may use a given machine translation system to translate 10 million sentences, while also wanting to ensure that all translations are good, e.g., of at least some threshold quality. By way of example, the quality threshold may only be met by the top 30-40% of the translations (or more or less). There may be a large cost factor in terms of human and/or computing resources to check all 10 million sentences and do post-editing. However, if quality estimation (QE) scores are provided along with translations, a threshold may be set for translations to review. Here, for instance, the service provider may only pick the lowest 10,000 sentences (or set a threshold QE score) and send those sentences falling below the threshold to experts for post-editing. In such a scenario, the costs associated with post-editing could be reduced 99.9% percent when compared to performing post-edit evaluations on the entire set of translations.

There are also scenarios where post-editing may not be required, but a fast turnaround time is required. In such cases, it may be particularly beneficial for the service provider to only publish good quality translations. Here, the lower quality translations that fall below the threshold may be maintained as source language. In this type of situation, an MTQP score can provide a reliable metric for only picking up (or otherwise selecting) high-quality translation sentences.

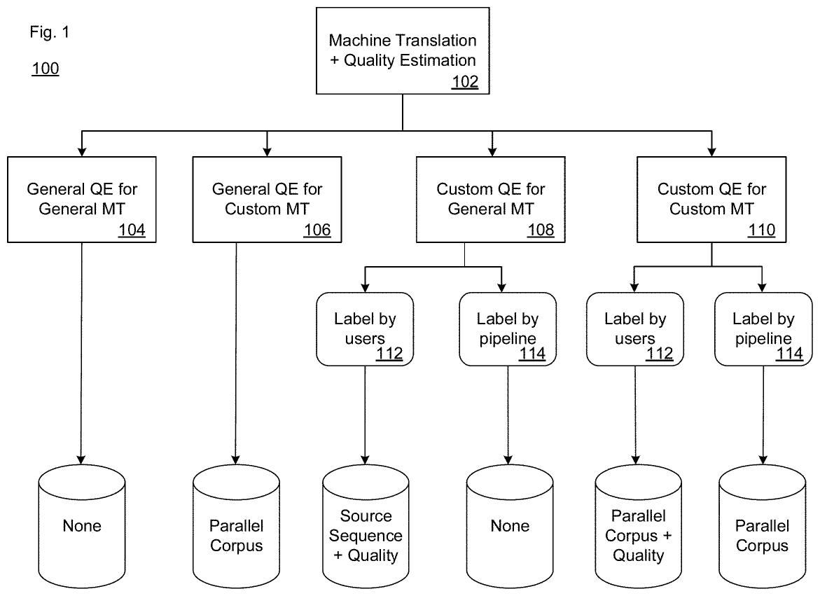

FIG. 1 illustrates a set of examples 100 of different scenarios having different approaches to address translations. For instance, while a system could just employ quality estimation (QE), it could alternatively use machine translation plus QE as shown in block 102. Here, for each source sentence provided (e.g., received from application service provider or other customer), the system generates a translation sentence in a selected language as well as a QE score.

As shown in the level below block 102, the system may use either general or custom QE, and general or custom machine translation. For general QE, [source sentence and translation output] pairs are provided, and the general QE model (e.g., trained by some general data labeled by the system) is used to predict a quality score for each sentence pair. For custom QE, a dataset is provided that comprises [source sentence, translation output, quality label] pairs. Here, the system fine-tunes or retrains the QE model based on [source sentence, translation output] pairs. In this case, the customized QE model can be used to predict quality score for each sentence pair. For general machine translation, received source sentences are used by a neural machine translation (NMT) model to generate translation sentences. And for custom machine translation, the system employs a parallel corpus. Here, the system fine-tunes the NMT model to derive a custom machine translation model. Source sentences are applied to the custom machine translation model to generate translation sentences.

Block 104 shows a configuration using general QE for general machine translation. Block 106 shows a configuration using general QE for custom machine translation. Block 108 shows a configuration using custom QE for general machine translation. And block 110 shows a configuration using custom QE for custom machine translation. Each of these may be suited to different customers' needs, for instance depending on whether the customer has the ability to provide its own data quality labeling and/or its own data set.

Blocks 112 show options where data is labeled by users (e.g., customers), and blocks 114 show options where data is labeled by the system pipeline. For user-labeled data of blocks 112, the users are responsible for choosing which sentences in the dataset to label, as well as labeling the QE score. This approach allows users to design their own labeling rules and/or follow guideline for the MTQP system. For labeling according to the system pipeline as in block 114, the pipeline can be used for labeling not only the general QE data to train the general QE model, but also the translation output for the user's data. In addition, for applications where a general QE approach is satisfactory, there may not be a need for custom QE. In contrast, in applications where the data may be field-specific, such as for movies or other videos, a custom QE+custom machine translation approach may be most appropriate.

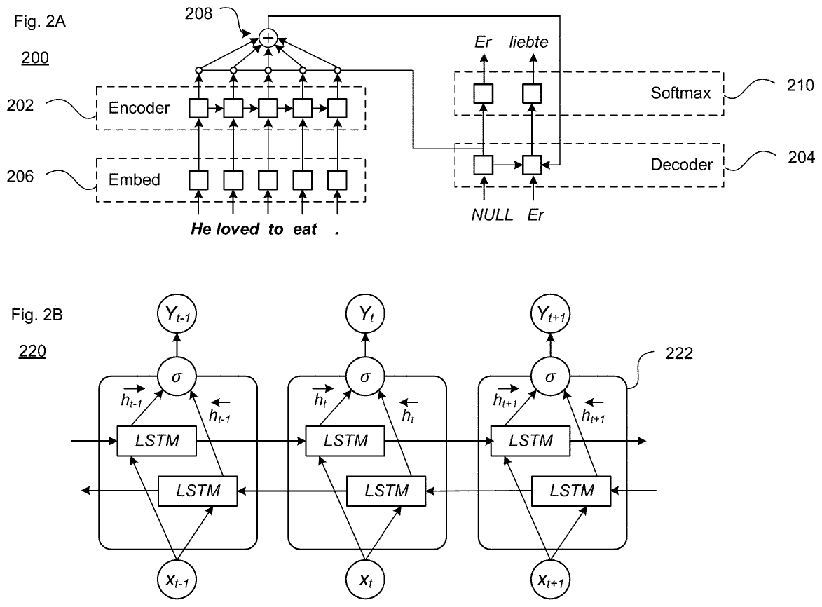

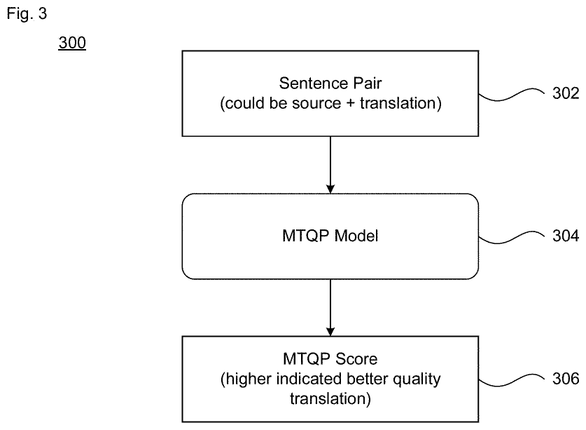

FIG. 2A illustrates an example 200 of quasi-machine translation (Quasi-MT) model of a transformer for an encoder 202 and decoder 204. As shown, a source sentence (e.g., “He loved to eat.”) is input to the embed block 206, which is fed to the encoder 202. The training may be done using a set of parallel data. The encoder 202 operates on the data received from embed block 206, and the outputs are added together at 208 (along with output from the NULL block of the decoder 204). The embed block 206 embeds each word to a vector in the embedding space (e.g., a 1024-dimension vector). The NULL block can act like a placeholder, or the start symbol, since when the model tries to predict the first word in a translation, there is no preceding word that could be used. The added outputs at 208 are fed to the decoder 204, and output from the decoder 204 is fed to a softmax block 210. The softmax block 210 is configured to assign fractional (e.g., decimal) probabilities to possible output. The probabilities must add up to 1.0.

By way of example, the Quasi-MT model 200 is trained to predict each token based on the source sentence from the translation output. Given a source sentence [a, b, c] and a translation sentence [A, B, C, D], the Quasi-MT model 200 seeks to predict each token in translation sentence based on “source sentence+bi-directional information in translation sentence”. More specifically in this example, the model attempts to predict “A” based on [a, b, c] and [B, C, D]; predict “B” based on [a, b, c] and [A, C, D]; predict “C” based on [a, b, c] and [A, B, D]; and predict “D” based on [a, b, c] and [A, B, C]. These predictions are done in parallel (independent from each other).

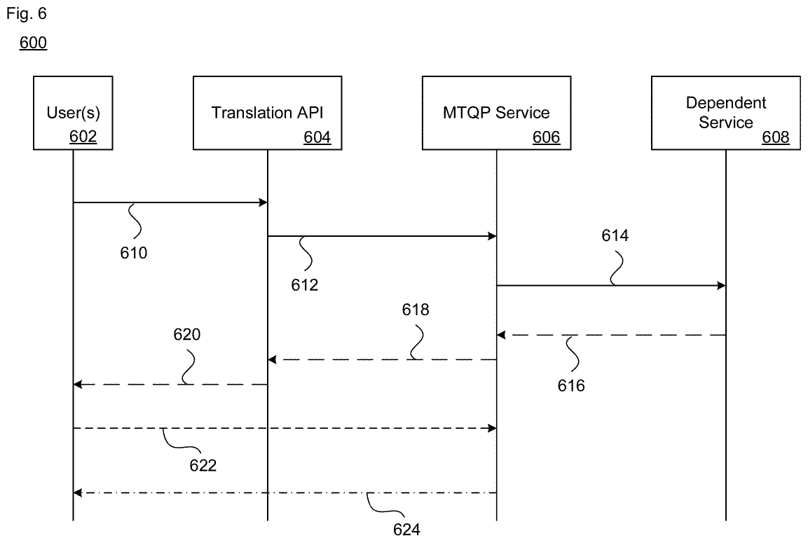

FIG. 2B illustrates an example 200 of a bidirectional LSTM (Bi-LS™) type recurrent neural network (RNN) for a QE model, in which the features generated by the quasi-machine translation module 200 are applied. The features could be generated by other feature extractors, such as a NMT Feature Extractor (see 504b in FIG. 5). Each feature extractor has its own LSTM to process the internal scores and produce a fixed length feature vector. Then the feature vectors are concatenated. For instance, QE data from the softmax block 210 is applied to the hidden layers of the Bi-LSTM in order to make a final prediction. The Bi-LSTM can be trained together with a feedforward neural network (see 508 in FIG. 5), and could also fine tune the feature extractor.

The data for training the Quasi-MT model can be a large parallel corpus, which is [source sentence, gold-label sentence] pairs. For training QE model, the data can be MTQP data, which is [source sentence, translation output, quality label] pairs.

### Training Datasets

For any machine learning problem with sentence pairs as input, such as textual entailment, semantic similarity, etc., the MTQP approaches discussed herein can be used as a feature score for the input. It is important to note that the effectiveness of a machine translation system can be limited by the quality of the data used to train the machine translation model(s). In particular, for models trained on sentence pairs, the performance of a given model may be highly dependent on the quality of the dataset. A large number of sentence pairs may be collected (e.g., hundreds of thousands, millions or more), and then the MTQP service is used to score all sentence pairs and only keep high-quality sentence pairs in the dataset. However, in some situations it can be beneficial to avoid using the same MTQP service on the trained machine translation models to avoid bias.

### MTQP Model Structure

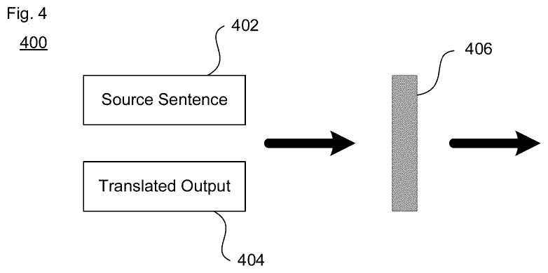

As discussed herein, the MTQP model takes a sentence pair as the input, and returns a (predicted) score as the output. FIG. 3 illustrates a general overview 300 of the model process. As shown in block 302, a sentence pair is provided. The pairs may come from preexisting (legacy) data, such as data previously collected for an app. For instance, sentence pairs may be sampled from a mixture of translations and web-sourced data, with labeling applied if the sentence pair has a consistent meaning. The pairs may also come from mined data, such as sentence pairs mined from the web. Here, the system may crawl the web to obtain translation pairs. In this case, the different languages could come from different parts of the same text. At block 304 the sentence pairs are input to the MTQP model. And at block 306, the MTQP model generates a predicted MTQP score. This includes aggregating any internal scores. Higher scores indicate better quality (more faithful) translations from the source language to the translated language. A threshold is used to cull lower quality (less faithful) translations, so that the translations that pass the threshold can be used to train a new translation model.

According to one aspect of the technology, there may be different tiers for the predicted MTQP score. For instance, in a tier 1 scenario, a neural machine translation model may be fixed (static), which means that no training is needed for this model (or it has been previously trained offline). Here, the language pairs that are supported depend on the neural machine translation model. The tier 1 scenario can be used to obtain a forced decoding score, which is calculated by summing up the cross-entropy (e.g., the log probability) of each token, and then normalizing (divide) by the sentence length.

For example, the input sentence pair may be (“a b c d”, f g″). The following steps can be performed to calculate the forced decoding score (FDS). First, run the translation model on this sentence pair, and at each token in the second sentence, the model will produce a probability distribution. Assume that the distribution produced at the first token is {a:0.5, b:0.3, e:0.1, g:0.1}. Then the log probability for “e” at the first token is log(0.1). Similarly, the log probability for “f” can be obtained at the second token and “g” at the third token. Finally, the system can sum up all of the log probabilities and divide by the number of tokens (e.g., sentence length), which is 3 in this example. This score is the forced decoding score. A benefit to this approach is that it does not require additional training data. It is also applicable to the machine translation-supported language pairs.

Other tier scores, such as tier 2 and tier 3 scores, may be produced by the same model structure, but which are trained on different data sets either statically (tier 2) or dynamically (tier 3). Unlike the approach for tier 1, these other tiers need to be trained. By way of example, a tier 2 approach may be particularly beneficial for users (or apps) that require very high quality MTQP scores. In this case, a large training set can be collected for some popular language pairs, and the system may train a general model for each of those language pairs. Here, the model is static (trained offline). Each entry in the dataset contains a source sentence, a translation sentence produced by the machine translation system, and a label to indicate whether the translation is good enough. In this way, the MTQP model is able to learn to distinguish between good and bad translations. However, human labeling for a large data collection is expensive (considering the annotator needs to be a bilingual speaker who can determine if a translation is good or not), especially for low-resource languages. A tier 2 approach may employ around 100,000 samples (e.g., on the order of 80,000-120,000 samples) to train and validate the general MTQP model.

In one example of a tier 3 (dynamic training) approach, the user could provide custom training data to train a customized MTQP model. For instance, this may involve around 15,000 (e.g., on the order of 10,000-20,000) samples to train a customized MTQP model from scratch. The data size employed for fine-tuning from the general MTQP model could be much smaller, such as ⅓ the size (e.g., 5,000 samples). Here, because the custom training data may be tailored to a specific app (e.g., subtitles for a movie), it can produce very effective results.

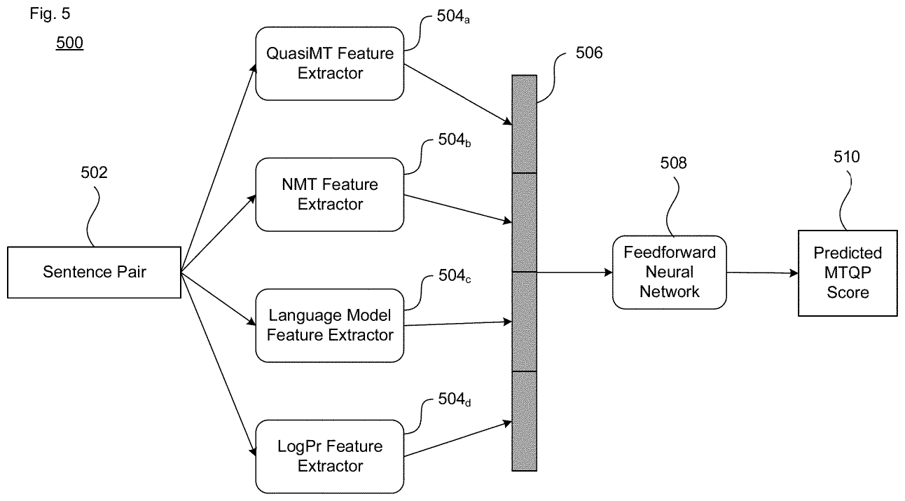

As shown in view 400 of FIG. 4, for a tier 2 or tier 3 approach, a source sentence 402 and a translated output 404 are projected to a feature vector 406. The feature vector 406 is used to find the closest embedding sentence in the other language, and then the MTQP model is used to score the (source, translation) pairs. Classification and/or regression can be applied to the generated feature vector 406. For instance, streams of vector values are fed as input to the classifier that builds the MTQP model. As discussed further below, these tiers may noticeably outperform the tier 1 approach.

FIG. 5 illustrates an example technical implementation 500 of the model structure that can be employed with a tier 2 or a tier 3 approach to generate a predicted MTQP score. Sentence pair [source sentence, translated output] 502 is fed to one or more feature extractors 504. For each sentence pair, each feature extractor produced one feature vector. As shown in this example, the feature extractors comprise a quasiMT feature extractor 504ₐ, an NMT feature extractor 504_{b} a language model feature extractor 504_{c}, and a LogPr feature extractor 504_{d}. The feature vectors produced by the feature extractors 504 are concatenated together at block 506. The concatenated feature vectors are applied to a feedforward neural network at block 508 to project the concatenated feature to a predicted score 510. Once trained, the model can be used for filtering. For instance, the model can be used to discard or otherwise flag low-scoring pairs that fall below a selected threshold. By way of example, the threshold may be selected based on the types of sentences being translated, the application (e.g., subtitling of movies), historical translation information, human labeling of a given data set, etc. In one scenario, for different language pairs, a subset of the data may be labeled to identify what percentage is satisfactory (e.g., 30%, 70% or some other threshold).

For the classification setting, the predicted score is a n-dim vector, where n is the number of classes, and each score represents the probability of that class. And for regression setting, the predicted score is a single value. When in a training mode, the loss is calculated and the gradient can be back propagated to update parameters in the MTQP model. For instance, a gradient descent approach, which finds a local minimum, can be used when training the MTQP model. For the classification setting, the loss is cross-entropy loss. For the regression setting, the loss is Mean Squared Error (MSE). In one scenario, the predicted scores 510 may be normalized, for instance to make the distribution of predicted scores similar across different languages.

The quasiMT feature extractor 504 uses the internal scores of a Quasi-MT model, which is trained on a large parallel sentence corpus. The Quasi-MT model is trained by trying to predict each token in a gold-label sentence by using the information in both the source sentence and the gold-label sentence. For example, in view of the discussion above regarding Quasi-MT model 200, assume there is a source sentence [a, b, c] and a gold-label sentence [A, B, C, D]. In this case, predict A with [a, b, c] and [B, C, D]. Predict B with [a, b, c] and [A, C, D]. Predict C with [a, b, c] and [A, B, D]. And predict D with [a, b, c] and [A, B, C]. Note that for a conventional MT model, a beam search is needed when the model generates a translation during inference time, where it processes one token at a time (in a sequential manner). However, because Quasi-MT processes all tokens at the same time, a beam search is not needed.

The NMT feature extractor 504_{b} uses internal scores from the encoder and decoder of the NMT translation model. Here, use of the encoder scores is optional. Besides these internal scores, this feature extractor may also use the mismatching features and Monte-Carlo dropout word-level confidence features. For using internal scores in the decoder, it uses the output of the decoder (204 in FIG. 2A) before the softmax layer. After feeding those scores into the LSTM, a fixed length feature vector is obtained. Internal scores in the encoder are similar to the output of 202 in FIG. 2A. All features except for the decoder scores are optional. In an attempt to characterize MT model uncertainty on a given input, Monte-Carlo is employed, where for feature extractors the system can run the underlying MT model several times, each time with a different drop-out mask for the same drop-out probability value. Here, the mean and variance for each of the target log-probabilities log are concatenated to the other target side MT-derived features before LSTM encoding to fixed dimensionality.

The language model feature extractor 504_{c} uses internal scores from two kinds of language models. The first one is a language model trained on a large corpus of the source language. The second one is a contrastive language model which is first trained on the large corpus and then incrementally trained on the corpus formed by source sentences in the training sentence pairs. In addition to the internal scores from the two kinds of language models, this feature extractor also has the mismatch and entropy features as in the NMT feature extractor. The entropy (Hₖ) may be obtained from a predictor P, according to the following: Hₖ=Σₜ_{ₖ} P(tₖ)log (P(tₖ)), where tₖ denotes a running token at position k. By way of example, P(tₖ) can come from either the NMT model, or the language model.

The source-side language model feature extractor 504_{c} can be extended by using a contrastive language model, in which a second (adapted) language model is trained on the confidence estimation training data incrementally from the previous one. The aim of this second language model is to capture differences between the domain in which the machine translation and confidence estimation models are to be employed, and the domain in which the machine translation model was trained. Here, the same features as for the base language model are used for the adapted language model. In the case of using a contrastive language model feature extractor, the concatenation of the feature sequences from the two language models can be augmented with two difference features and sent to the LSTM layer that encodes into a fixed dimensional feature, where:

arg maxP_{base}(sₖ)==arg maxP_{adopted}(sₖ)(binary)

log P_{base}(sₖ*)−log P_{adopted}(skₖ*)

The LogPr feature extractor 504d calculates log P(target|source)/len(target) from an NMT model as a single feature, based on the target (translated) sentence and the source sentence. Len(target) is the length of the target. The log P(t) produced by the NMT model at each position k in the target sentence T=[tₗ, . . . , tₖ, . . . , t_{{length(T3}}] is summed over all k=1 . . . length(T):

log P(T)=Σₖ log Pₜ_{ₖ}

Ideally, the calculated value is equivalent to the forced decoding score.

Various adjustments may be made to the model structure. For instance, to evaluate confidence in the model, it may be run multiple times with different dropout rates, or generate different top-n candidates during decoding. The more diverse results, the less confident is the model, and the lower MTQP score that should be produced. Dropout involves dropping out nodes at random during training. By way of example, the top-n candidates may have an n value of 5, or more or less.

A back translation forced decoding score can also be used to evaluate system performance. For instance, as the forced decoding score for each sentence pair could be calculated directly, the system can switch the sentence pair and calculate the forced decoding score again, which is the back translation forced decoding score. Then using those two forced decoding scores, the system can combine them (for example, just take average value) to see if the performance is better. This would involve adding the FDS and back translation FDS into the features. Just as mismatching features, the system can add any FDS features, which can make the MTQP model better because there would be more features overall.

In another scenario, the NMT decoder may generate posterior probability lattices. In this case, the posterior probability for each token on the target side could be used for confidence scoring. This functionality is also applicable in other areas, e.g., generating alternatives for a given token/phrase on the target side.

### Evaluation Metrics and Testing

It can be beneficial to control the amount of noise introduced in the downstream machine translation pipeline. In order to help evaluate performance, different metrics may be employed. For instance, to evaluate noise (or whether the translation data is accurate enough to be used by the translation system), a primary performance metric R@P=t can be used. Here, R denotes recall (or sensitivity), which corresponds to a percentage of relevant instances that were retrieved by the system. P denotes precision (or the positive predictive value), which corresponds to a percentage of relevant instances from the total number of retrieved instances. In this evaluation, precision maximizes recall subject to the constraint of precision being above the threshold t.

Setting a high value for t controls the amount of noise introduced in the downstream pipeline. By way of example, a value oft on the order of 0.9 (e.g., +/−10%) provides sufficient precision for most machine translation situations. Having a t=0.9 means that when the user directly uses those translations with a high MTQP score, 90% of them are truly good translations (that would not require post-editing). In other examples, t may be higher or lower than 0.9. This parameter may be tunable, for instance based on the type of information being translated, the type of application (e.g., video subtitles, scientific paper translations, etc.) or other factors.

In the classification setting, where the data label is binary, evaluation metrics that take the area under the curve (AUC) of the precision-recall curve, or the AUC of the receiver operating characteristic curve, may also be employed. And in the regression setting, where the data label may have a value between 0 and 1, one or more of the following metrics may be employed: mean squared error (MSE), mean absolute error (MAE), the Pearson correlation coefficient (Pearson), Spearman's rank correlation coefficient (Spearman), or the Kendall rank correlation coefficient (Kendall). For situations where the data set is provided by a user, the metric information may be considered by the user for setting operating criteria. For instance, the precision-recall curve information may be used to decide the operation point (e.g., to set t).

By way of example only for a tier 3 score using a custom-trained MTQP model, the primary performance metric may be: 0.2 R@P=0.9, which means to achieve at least 0.2 recall when the precision is 0.9. Both the recall value and the precision value may vary, e.g., by 5-15%, or more or less. For tier 1 and tier 2 scores, the target value t could be loosened, e.g., to between 0.75-0.85.

The following is an example evaluation for parallel sentence mining comparing the forced decoding score of tier 1 with the MTQP score of tier 3. In this example the data sources may include legacy data, such as sampled sentence pairs from a mixture of translations and web data, with labeling on a sentence pair that has consistent meaning. The data sources may also include mined data, where the sentence pairs are mined from a large corpus, e.g., from natural data the web. Here, the mined data may not be translation data. According to one example, the system may split all sentences that appeared on the web into deduped monolingual sentences, and filter high quality portions using a sentence quality score. From this, sentence pairs may be mined directly from the monolingual sentences using language-agnostic embeddings. In one scenario, the legacy data has about 30,000 sentence pairs and the mined data has about 10,000 sentence pairs. The language pairs evaluated include: English (En)-Chinese (Zh), English (En)-Russian (Ru), English (En)-Hindi (Hi), English (En)-French (Fr), English (En)-Spanish (Es), and English (En) Portuguese (Pt).

Table 1 illustrates scores where the primary performance evaluation metric is R@P=0.9.

TABLE 1
R@P = 0.9

| Score | En:Zh | En:Ru | En:Hi | En:Fr | En:Es | En:Pt |
|---|---|---|---|---|---|---|
| Forced Decoding | 0.137 | 0.049 | 0.059 | 0.260 | 0.256 | 0.229 |
| Score (Tier 1) | | | | | | |
| MTQP Score | 0.315 | 0.250 | 0.167 | 0.215 | 0.353 | 0.335 |
| (Tier 3) | | | | | | |

Table 2 illustrates scores where the primary performance evaluation metric is R@P=0.8.

TABLE 2
R@P = 0.8

| Score | En:Zh | En:Ru | En:Hi | En:Fr | En:Es | En:Pt |
|---|---|---|---|---|---|---|
| Forced Decoding | 0.310 | 0.492 | 0.222 | 0.488 | 0.502 | 0.412 |
| Score (Tier 1) | | | | | | |
| MTQP Score | 0.467 | 0.505 | 0.358 | 0.483 | 0.621 | 0.517 |
| (Tier 3) | | | | | | |

As can be seen, the MTQP score outperforms (i.e., is higher) than the forced decoding score for each language translation except En:Fr, and for some languages is 50% or higher than the forced decoding score.

Another metric may be used to show how well the forced decoding score model and the MTQP model perform when the top translation samples are considered. This metric may be calculated by first ranking the samples according to the predicted scores (forced decoding score or MTQP score). Then, the top X percentile are selected (e.g., 10%, 15%, 20%, 25% and 30%). For each top X percentile, count how many samples of the group provide satisfactory translations (e.g., that would not require any post-editing), and how many samples provide unsatisfactory translations (e.g., that may require significant post-editing). Note that there may be translations that fall in between satisfactory and unsatisfactory because they may require a minimal amount of post-editing. Based on such criteria, this metric is shown below in Table 3 for the En:Zh machine translations, where X is evaluated between 10% and 30%.

TABLE 3
Evaluating top translation samples

| En:Zh | Forced Decoding Score Model (Tier 1) | | MTQP Model (Tier 3) | |
|---|---|---|---|---|
| Percen- | Satis- | Unsatis- | Satis- | Unsatis- |
| tile | factory | factory | factory | factory |
| 30.00% | 68.87% | 6.29% | 73.51% | 5.63% |
| 25.00% | 72.00% | 4.40% | 77.20% | 4.80% |
| 20.00% | 77.50% | 4.50% | 84.16% | 1.98% |
| 15.00% | 80.79% | 3.31% | 88.00% | 1.33% |
| 10.00% | 85.00% | 2.00% | 93.33% | 0.00% |

Tables 4 and 5 illustrate examples of other metrics as applied to training with classification or regression for a tier 3 MTQP approach, as compared to a tier 1 forced decoding score approach. Table 4 shows the results for English to French translation, and table 5 shows the results for English to Russian translation. In these examples, R@P=0.9. For MSE or MAE, a lower value indicates a higher quality machine translation, while for Pearson, Spearman, Kendall and R@P, a larger value indicates a higher quality machine translation.

TABLE 4
Training Strategies (En:Fr)

| | | | | | | R@P = |
|---|---|---|---|---|---|---|
| Training Strategy | MSE | MAE | Pearson | Spearman | Kendall | 0.9 |
| Tier 1 | 0.138 | 0.309 | 0.344 | 0.334 | 0.246 | 0.058 |
| Tier 3: | 0.111 | 0.259 | 0.503 | 0.576 | 0.414 | 0.317 |
| Classification | | | | | | |
| Tier 3: | 0.059 | 0.164 | 0.535 | 0.551 | 0.411 | 0.256 |
| Regression | | | | | | |

TABLE 5
Training Strategies (En:Ru)

| | | | | | | R@P = |
|---|---|---|---|---|---|---|
| Training Strategy | MSE | MAE | Pearson | Spearman | Kendall | 0.9 |
| Tier 1 | 0.142 | 0.317 | 0.533 | 0.522 | 0.397 | 0.378 |
| Tier 3: | 0.106 | 0.203 | 0.618 | 0.649 | 0.489 | 0.657 |
| Classification | | | | | | |
| Tier 3: | 0.052 | 0.144 | 0.675 | 0.653 | 0.501 | 0.667 |
| Regression | | | | | | |

It can be seen that both the classification and regression training strategies perform comparably across various metrics. The actual performance can depend on the particular language pair. However, in some situations the classification approach may be more suitable, for instance when the translation memory could be easily converted to training data. In addition, the classification setting may be compatible with regression data, but not vice versa, because the regression label could be converted to binary label by setting a threshold.

### System Architecture

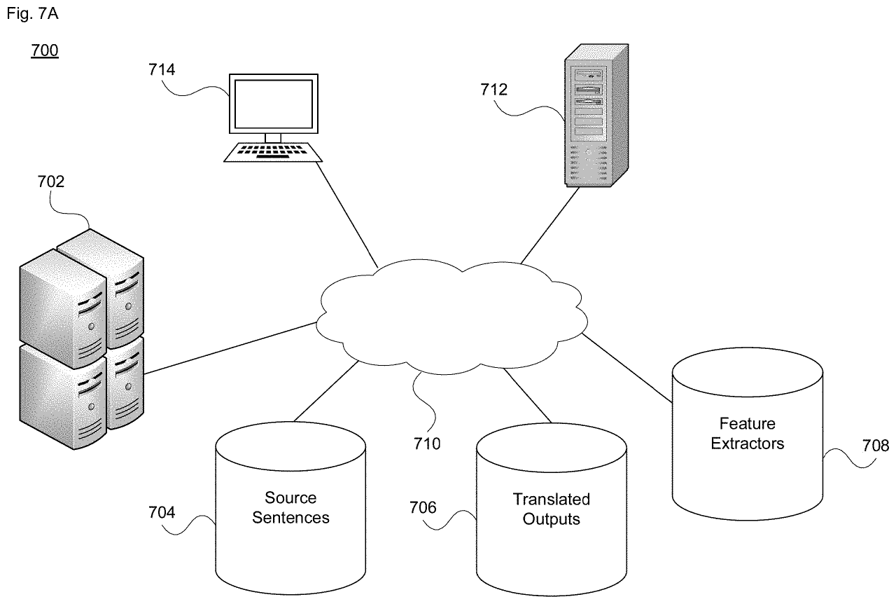

FIG. 6 illustrates one MTQP model workflow 600, for instance where an MTQP service is used in an online manner such as with a translation application programming interface (API). As shown, there may be several parts to the system, including one or more users 602, a translation API 604, an MTQP service 606, and a dependent service 608. For example, when the user calls the translation API 604 for a source sentence, a flag could be specified in which the translation API 604 will return a translation sentence along with the MTQP score. The user 602 may be an end user or other customer, whether external (a third-party customer) or internal. In one example, the user 602 may be an external application service provider or internal service that provides video streaming with subtitles. In other examples, the user 602 may use predicted quality scores in a variety of ways, such as to: determine whether a machine translation can be used without post-editing, select a best translation from among multiple sources, provide higher quality accurate machine validation, provide more cost-effective human quality review (e.g., by targeting specific translations), as a signal to improve machine learning models, refine descriptions in different languages based on the quality score, to rank video (or audio) content with good local captions, subtitles or descriptions, etc. The dependent service 608 may maintain the training model, and the system may send remote procedure calls (RPCs) to evaluate sentence pairs.

As shown by arrow 610, the user 602 may send a request to the translation API 604. Here, the request includes one or more source sentences. As shown by arrow 612, the translation API 604 sends a request to the MTQP service 606, which includes the received source sentence(s) and one or more translated sentences. As shown by arrow 614, the MTQP service 606 requests that the dependent service 608 perform model inference, and per arrow 616 the dependent service 608 returns a predicted score. For instance, when sentence pairs arrive at the MTQP service 606, preprocessing can be performed to convert those sentence pairs into tensors that could be consumed by the MTQP model. The tensors are then passed to the dependent service, where the MTQP model is served. After getting the output tensor back (arrow 616), the MTQP service 606 performs post-processing to convert the tensors to predicted MTQP scores. Based on the predicted score, the MTQP service 606 returns an MTQP score to the translation API 604, as shown by arrow 618. The translation API 604 returns the translated sentence(s) with the MTQP score(s) as shown by arrow 620. Alternatively, as shown by arrow 622, the user 604 may send a request with a source sentence and a translated sentence directly to the MTQP service 606. Here, in response the MTQP service 606 (after performing model inference and receiving the predicted score) provides the MTQP score to the user 602 directly. Based on the MTQP scores for the translated sentences, the system may flag translated sentences that fall below a quality threshold, and modify a translation database based on this. Alternatively, the translated sentences that satisfy the quality threshold may be flagged and the database updated accordingly. The user(s) may access the high-quality translations and use them in various applications. Conversely, the translations flagged as not satisfying the quality threshold may be post-edited with adjustments so that they would meet the quality threshold. Thus, according to one aspect of the technology, nothing will be discarded even if a translated sentence falls below the quality threshold. By providing the MTQP scores to the user(s), this leaves the choice to the user(s) about what to do with those scores.

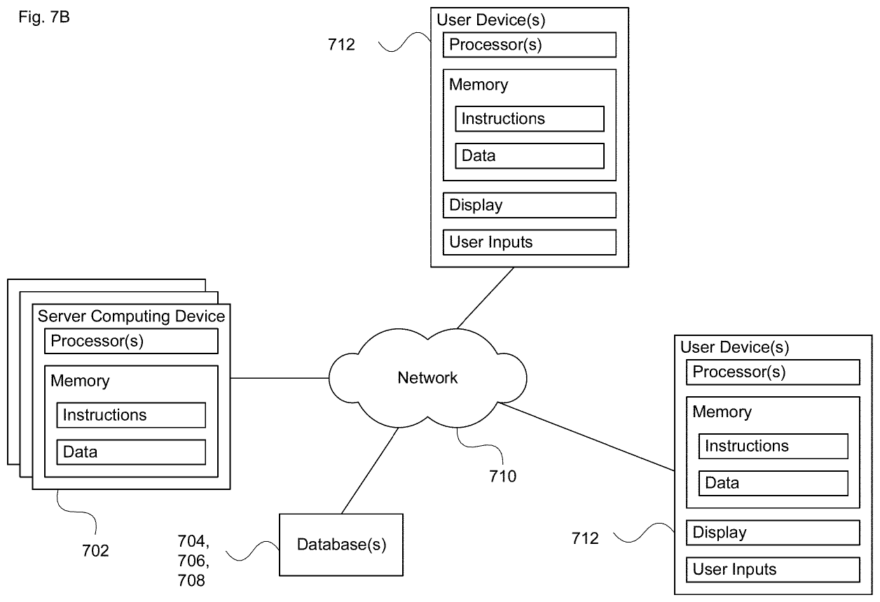

TPU, CPU or other computing architectures can be employed to implement MTQP model approach in accordance with the features disclosed herein. One example computing architecture is shown in FIGS. 7A and 7B. In particular, FIGS. 7A and 7B are pictorial and functional diagrams, respectively, of an example system 700 that includes a plurality of computing devices and databases connected via a network. For instance, computing device(s) 702 may be a cloud-based server system. Databases 704, 706 and 708 may store, e.g., a corpus of source sentences, a corpus of translated outputs, and different feature extractors (such as the QuasiMT feature extractor, the NMT feature extractor, the language model feature extractor and/or the LogPr feature extractor), respectively. The server system may access the databases via network 710. One or more user devices or systems may include a computing system 712 and a desktop computer 714, for instance to provide a parallel corpus and/or other information to the computing device(s) 702.

As shown in FIG. 7B, each of the computing devices 702 and 712-714 may include one or more processors, memory, data and instructions. The memory stores information accessible by the one or more processors, including instructions and data (e.g., machine translation model, parallel corpus information, feature extractors, etc) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, etc. Alternatively, each processor may be a dedicated device such as an ASIC or other hardware-based processor. Although FIG. 7B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 702. Accordingly, references to a processor or computing device will be understood to include references to a collection of processors or computing devices or memories that may or may not operate in parallel.

The input data, such as source sentences or translated outputs, may be operated on by the MTQP module to generate one or more predicted scores and associated information. The predicted scores may be used to filter the translation results so that only results exceeding a threshold (e.g., the top 10-40%) are provided to or otherwise utilized by the user. The user devices may utilize such information in various apps or other programs to provide accurate, high quality translations in accordance with a variety of applications as discussed herein. For instance, this can include using the scoring as a filter to identify high-quality sentence pairs to use as training data for a better translation model. According to one aspect of the technology, MTQP-analyzed data (sentence pairs) is used to perform NMT training data filtering. For instance, quality predictions from the MTQP model are used to “nominate” sentence pairs, e.g., as labeling data. This enables the system to curate a more suitable data set (with quality predictions satisfying some quality metric) that is then used to train machine translation models (e.g., an NMT model).

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-related computing devices (e.g., 712-714) may communicate with a back-end computing system (e.g., server 702) via one or more networks, such as network 710. The network 710, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 702 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 702 may include one or more server computing devices that are capable of communicating with any of the computing devices 712-714 via the network 710.

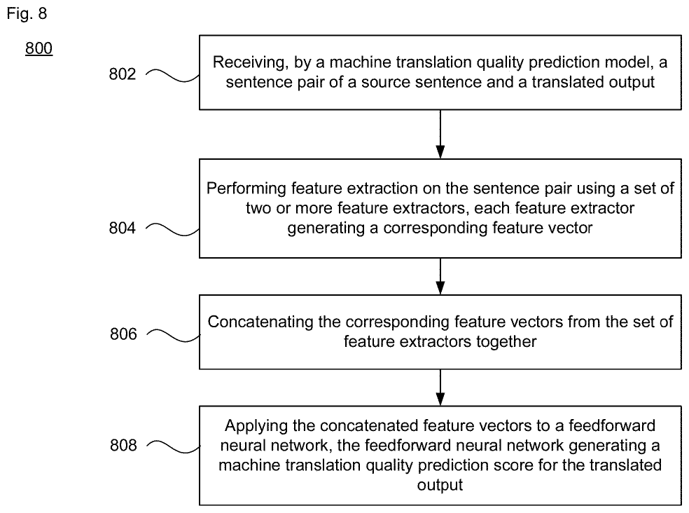

FIG. 8 illustrates a method 800 in accordance with aspects of the technology, which involves at block 802 receiving, by a machine translation quality prediction model, a sentence pair of a source sentence and a translated output. At block 804 the method involves performing feature extraction on the sentence pair using a set of two or more feature extractors, each feature extractor generating a corresponding feature vector. Then, at block 806, the corresponding feature vectors from the set of feature extractors are concatenated together. And at block 808 the method includes applying the concatenated feature vectors to a feedforward neural network. The feedforward neural network generates a machine translation quality prediction score for the translated output.

According to aspects of the technology, given a pair of sentences [a source sentence and a translation output], the MTQP service returns a score to indicate the quality of the translation. The MTQP score can be used in various ways by an application, service or other user. For instance, the score can be used to estimate the post-editing efforts for each sentence. Alternatively, post-editing may be omitted for high-quality translation output that exceeds a selected threshold. Here, the user can directly use the high-MTQP score translations and send other translations for post-editing (either automated or human post-editing), which saves the post-editing cost. In this situation, an upper bound threshold can be configured for translations that do not need post-editing. This approach can also improve the post-editing efficiency by bucketing scores with different queues for translators to concentrate on similar types of works.

In another scenario, the system may make sure that low-quality translations falling below the selected threshold are post-edited. Here, the user may not have strict requirements about the quality of the translations, which would mean that most machine translations would be acceptable, and there may only be a need to pick out very low-quality translations (for example, the bottom 10%, or more or less) and have those translations post-edited. In this situation, a lower bound threshold can be configured for translations that need post-editing. And yet another scenario, may involve direct human translation on poor machine translations. Here, the user can directly send source sentences for human translation and discard the corresponding machine translations with very low MTQP scores, because the poor translation could be misleading and the post-editor may need to take some time to read that translation. This approach removes the burden of poor machine translations and instead would utility the translator to do human translation directly.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer-implemented method comprising:
receiving, by a machine translation quality prediction model, a sentence pair of a source sentence and a translated output;
performing feature extraction on the sentence pair using a set of two or more feature extractors, each feature extractor generating a corresponding feature vector;
concatenating the corresponding feature vectors from the set of feature extractors together; and
applying the concatenated feature vectors to a feedforward neural network, the feedforward neural network generating a machine translation quality prediction score for the translated output.

2. The method of claim 1, further comprising storing the machine translation quality prediction score in a database in association with the translated output.

3. The method of claim 1, further comprising transmitting the machine translation quality prediction score to a user.

4. The method of claim 1, wherein the set of two or more feature extractors comprises at least two of a Quasi-MT feature extractor, a neural machine translation feature extractor, a language model extractor, and a LogPr feature extractor.

5. The method of claim 4, wherein the Quasi-MT feature extractor uses internal scores of a Quasi-MT model that is trained by trying to predict each token in a gold-label sentence by using information in both the source sentence and the gold-label sentence.

6. The method of claim 4, wherein the neural machine translation feature extractor uses internal scores from at least a decoder of a neural machine translation model.

7. The method of claim 4, wherein the language model extractor uses internal scores from two kinds of language models, a first one of the language models being trained on a selected corpus of a source language, and a second one of the language models being a contrastive language model that is first trained on the selected corpus and then incrementally trained on a corpus formed by source sentences in a set of training sentence pairs.

8. The method of claim 1, further comprising:
determining, by one or more processors, whether the machine translation quality prediction score exceeds a quality threshold; and
when the machine translation quality prediction score does not exceed the quality threshold, filtering the translated output.

9. The method of claim 8, wherein filtering the translated output comprises storing a flag with the translated output to indicate that the machine translation quality prediction score does not exceed the quality threshold.

10. The method of claim 8, wherein filtering the translated output comprises removing the translated output from a corpus of translated output sentences.

11. The method of claim 1, further comprising:
determining, by one or more processors, whether the machine translation quality prediction score exceeds a quality threshold; and
when the machine translation quality prediction score exceeds the quality threshold, adding the translated output to a corpus of translated output sentences.

12. The method of claim 1, further comprising:
training a machine translation model using the translated output when the machine translation quality prediction score exceeds a quality threshold.

13. The method of claim 1, further comprising:
creating a curated data set of source sentences and corresponding translated outputs, where each translated output exceeds a quality threshold; and
training a machine translation model using the curated data set.

14. The method of claim 13, wherein the trained machine translation model is a neural machine translation model.

15. A system comprising:
memory configured to store machine translation quality prediction information; and
one or more processors operatively coupled to the memory, the one or more processors being configured to implement a machine translation quality prediction model by:
reception of a sentence pair of a source sentence and a translated output:
performance of feature extraction on the sentence pair using a set of two or more feature extractors, each feature extractor generating a corresponding feature vector;
performing a concatenation of the corresponding feature vectors from the set of feature extractors together; and
application of the concatenated feature vectors to a feedforward neural network, the feedforward neural network configured to generate a machine translation quality prediction score for the translated output.

16. The system of claim 15, wherein the set of two or more feature extractors comprises at least two of a Quasi-MT feature extractor, a neural machine translation feature extractor, a language model extractor, and a LogPr feature extractor.

17. The system of claim 15, wherein the one or more processors are further configured to:
determine whether the machine translation quality prediction score exceeds a quality threshold; and
when the machine translation quality prediction score does not exceed the quality threshold, filter the translated output.

18. The system of claim 15, wherein the one or more processors are configured to filter the translated output by storing a flag with the translated output to indicate that the machine translation quality prediction score does not exceed the quality threshold.

19. The system of claim 15, wherein the one or more processors are further configured to:
determine whether the machine translation quality prediction score exceeds a quality threshold; and
when the machine translation quality prediction score exceeds the quality threshold, add the translated output to a corpus of translated output sentences.

20. The system of claim 15, wherein the one or more processors are further configured to train a machine translation model using the translated output when the machine translation quality prediction score exceeds a quality threshold.

21. The system of claim 15, wherein the one or more processors are further configured to:
create a curated data set of source sentences and corresponding translated outputs, where each translated output exceeds a quality threshold;
store the curated data set in the memory; and
train a machine translation model using the curated data set.
